(19) United States
(12) Patent Application Publication
(10) Pub. No.: US 2024/0278707 A1
(43) Pub. Date: Aug. 22, 2024

(54) WORK TRAILERS

(71) Applicant: Cody BABB, Twin Falls, ID (US)

(72) Inventor: Cody BABB, Twin Falls, ID (US)

(21) Appl. No.: 18/569,409

(22) PCT Filed: May 31, 2022
(86) PCT No.: PCT/US2022/031535

§ 371 Date: Dec. 12, 2023

Related U.S. Application Data
(60) Provisional application No. 63/202,520, filed on Jun. 15, 2021.

(51) Int. Cl. B60P 3/14; B60R 16/03

(52) U.S. Cl. CPC B60P 3/14; B60R 16/03

(57) ABSTRACT

Work trailers (10) are disclosed that include a platform (14) and a box (12) fixedly mounted on the platform. In some implementations the box extends substantially the entire length of the platform but covers only a portion of the width of the platform, leaving an exposed strip of platform running the length of the platform on either side of the box. The trailer includes a plurality of storage compartments, all of which are accessible from outside the trailer.

### BACKGROUND

Contractors working on construction and renovation jobs often utilize trailers to transport tools, materials, and other equipment to a jobsite. Most commercially available trailers are similar in structure to a basic enclosed utility trailer—i.e., essentially a metal box on wheels with a door in the back. These trailers are used by walking into the box from the back and utilizing the space within the box for storage. In some cases, there are hatches or doors in the sides of the box that allow the interior space to be accessed from the outside.

Issues with commercially available trailers include difficulties removing and returning heavy tools (such as table saws and the like), difficulty maneuvering the trailer, particularly on rough or winding roads, and not having all the resources needed for the job (water, power, shelter from the elements, etc.) readily available.

### SUMMARY

The present disclosure features work trailers for construction and other applications that have an advantageous distribution of weight, making them easy to pull even in challenging road conditions, and allow access to most or all of the stored materials from the outside of the trailer. In some implementations, the trailer is not designed to be walked into. In some implementations, the trailer is designed to provide a self-contained workspace providing the user with access to power, lighting, work bench space, and access to all stored items from outside of the trailer.

In one aspect, the disclosure features a work trailer that includes a trailer platform and a box fixedly mounted on the platform, the box extending substantially the entire length of the platform but covering only a portion of the width of the platform, leaving an exposed strip of platform running the length of the platform on either side of the box.

Some implementations include one or more of the following features.

The height of the trailer from the ground to the highest point may be less than 8 feet, for example 6 feet or less. The width of the box may be, for example, from about 3 to 6 feet. The width of the platform may be from about 4 feet to the widest legal limit on roads, e.g., from about 4 to 9 feet. The platform is preferably wider than the box by at least 2 feet. The box includes a plurality of storage areas accessible from outside the trailer. In some implementations the platform also includes storage areas accessible from outside the trailer. The exposed strips of platform may be configured for use as workspaces.

The box may include a rigid box frame modular bays that are reconfigurably mounted on the rigid frame, the bays providing box storage areas. The platform may include a rigid platform frame providing a three-dimensional scaffold. The platform may further include platform storage compartments that are disposed within the scaffold provided by the platform frame.

The trailer may include an electrical system including a power bank and wiring providing electrical communication between the power bank, a power source, and power outlets in the box. The electrical system may further include a breaker panel and/or a generator. The wiring may be routed through a frame of the box to the outlets. The electrical system may also include a Bluetooth® wireless system for controlling components of the trailer such as lighting and/or locks.

The trailer may include a rear compartment configured for storage of large rolling equipment and having one or more ramps to facilitate removal of the equipment from the rear compartment.

In another aspect, the present disclosure features a work trailer comprising: (a) a platform having an upper surface, the platform comprising (i) a trailer hitch, (ii) a platform frame mounted on one or more wheeled axles, the platform frame providing a three-dimensional scaffold, and (iii) a plurality of storage compartments within the scaffold, and, mounted on the platform frame, (b) a box comprising (i) a box frame mounted on the upper surface of the platform, and (ii) a plurality of bays secured within the box frame.

Some implementations may include one or more of the following features. The box-shaped frame may cover only a portion of the upper surface of the platform.

All of the compartments and bays may be accessible from outside of the work trailer. The box-shaped frame may be constructed of tubular members and the trailer may further include wiring extending through the tubular members from a power supply to outlets in the bays. The trailer may further include one or more tanks for liquid storage disposed within the platform frame. The box frame may be bolted to the platform frame to allow removal and replacement of the box. The height of the trailer from the ground to a highest point may be less than 8 feet.

In some implementations the trailer further includes an electrical system including a power bank and wiring providing electrical communication between the power bank, a power source, and power outlets in the box. The electrical system may further include a 12V lighting system, and/or any of the other features discussed above.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

### DESCRIPTION OF THE DRAWINGS

FIG. 1 is a perspective view of a trailer according to one implementation take from a first side.

FIG. 1A is a view similar to that in FIG. 1, but with some of the compartments on the first side in an open position.

FIG. 1B is a view similar to that in FIG. 1A, but showing a stowable tent deployed.

FIG. 2 is a perspective view of the trailer shown in FIG. 1, taken from the opposite side.

FIG. 2A is a view similar to that in FIG. 2, but with the compartments open.

FIG. 2B is similar to FIG. 2A, but is taken from a different angle and shows different open compartments and alternative features.

FIG. 2C is similar to FIG. 2B, but shows yet another combination of features.

FIG. 2D is an enlarged detail view of a portion of FIG. 2C, showing a large shelf that is partially deployed in FIG. 2C in a fully deployed position.

FIG. 3 is a front perspective view of the trailer of FIG. 1, showing the nose portion of the box.

FIG. 3A is similar to FIG. 3 but shows the front-end compartments in an open position.

FIG. 3B is a detail view of the front-end compartment in which the generator is stored.

FIG. 4 is similar to FIG. 1, but shows the trailer from behind, with the rear compartment in an open position and the ramp deployed.

FIG. 5 is similar to FIG. 2, but shows the trailer from behind, with the rear compartment open and the ramp deployed.

FIG. 6 is similar to FIGS. 4 and 5, but shows the rear compartment in further detail.

FIG. 6A is a partial detail view of FIG. 6, showing the ramp sections rotated outward to provide ramps for the exposed platform sections.

FIG. 7 is a top view of the platform prior to installation of the box.

FIG. 7A is a top view of the trailer, including the box and platform.

FIG. 8 is a detail view of one of the platform drawers.

FIG. 9 is a wiring diagram for the trailer according to one implementation.

FIG. 10 is a perspective view of the frame of the trailer according to one implementation.

FIG. 11 is a perspective view of the frame of the trailer taken from a different angle.

### DETAILED DESCRIPTION

The following description, and accompanying figures, refer to an exemplary configuration of a trailer according to one implementation. As will be discussed later, the trailer is customizable and can be manufactured using modular components that can allow for multiple different configurations of bays and compartments.

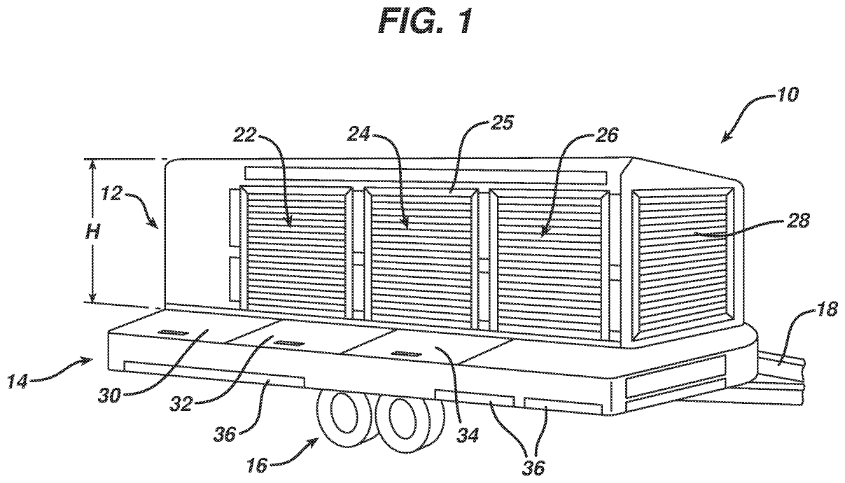

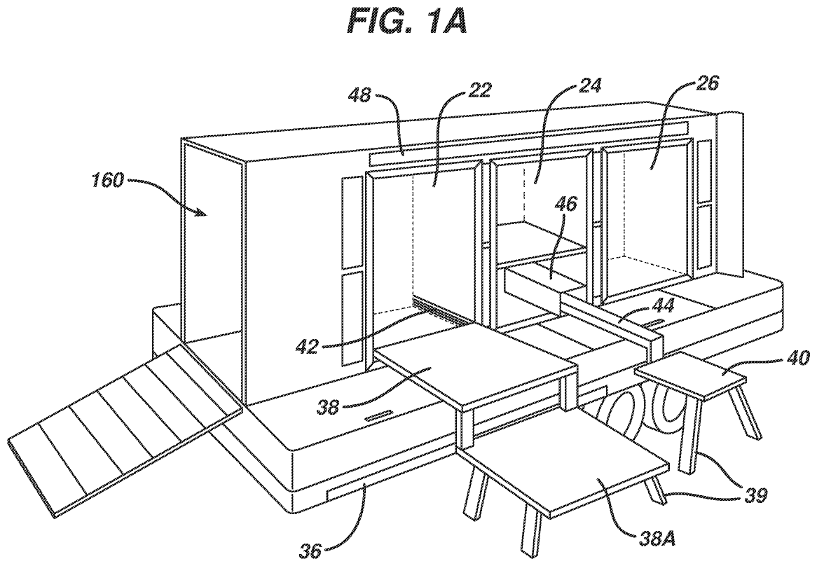

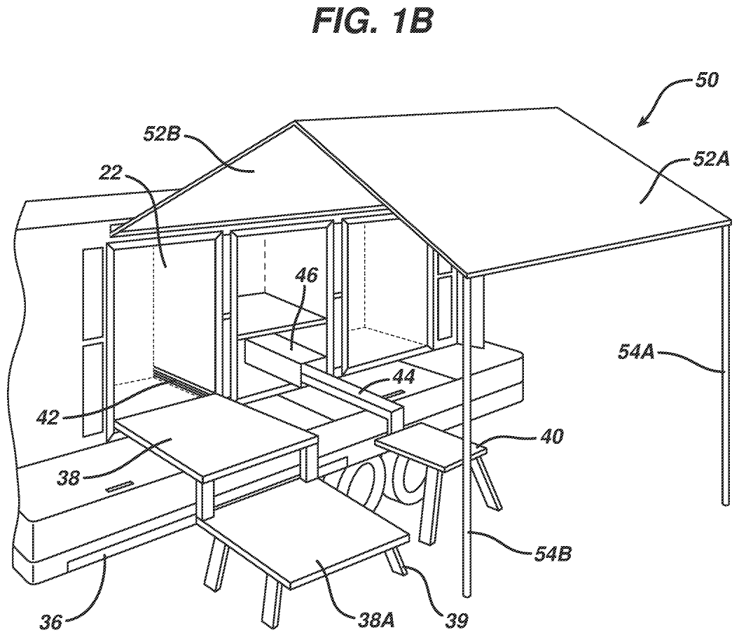

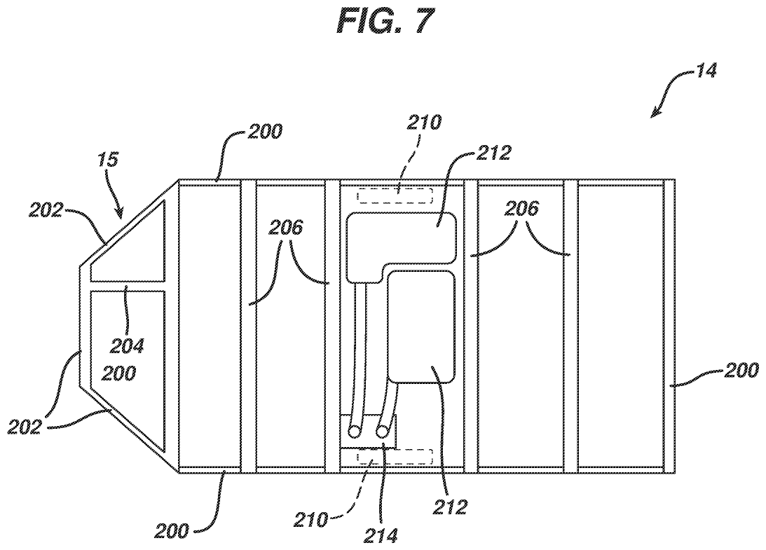

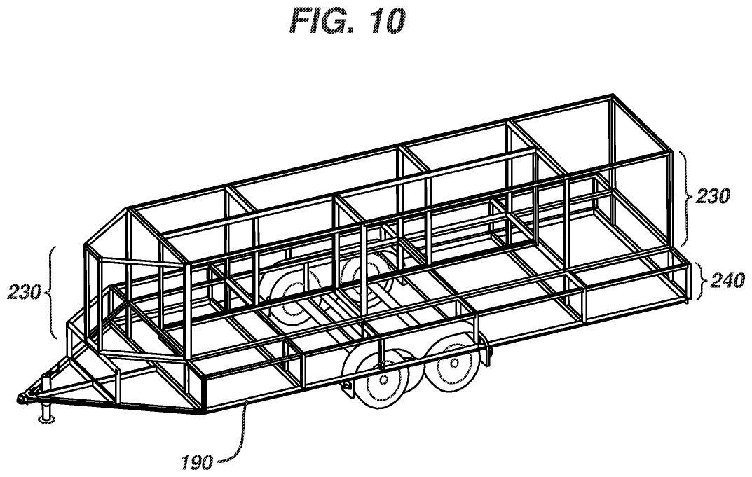

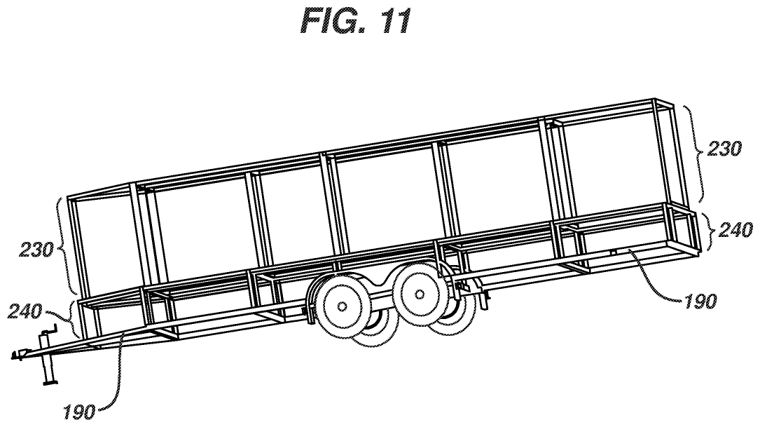

Referring to FIG. 1, a work trailer 10 according to one implementation includes a box 12 that is fixedly mounted on a platform 14. As shown in FIG. 7, platform 14 is generally rectangular except for its forward area 15 which is in the form of a truncated triangle. Platform 14 is supported on wheels 16 (a pair of which is positioned on each side of the platform) in a conventional manner. A hitch portion 18 extends forward of the platform 14 and is configured for attachment to a truck for towing, also in a conventional manner. As will be discussed in further detail below, in some implementations the box 12 includes a box frame 230 (FIGS. 10 and 11) on which a plurality of bays of different sizes are interchangeably mounted, providing a modular construction that allows customization of the trailer.

As can be seen in FIG. 7A, the box 12 extends substantially the entire length L of the platform, which may be for example from about 5 to 20 feet, e.g., 8 feet, 12 feet or 16 feet in some implementations. The platform is significantly wider than the box, and the box is centered on the platform, such that the platform is exposed on either side of the box. The platform may have a width W of, for example, 6 to 10 feet, e.g., 8 feet in some implementations. The exposed side areas 20A, 20B of the platform may be utilized in a number of different ways, as will be discussed in detail below. In some implementations, the box has a width W of from about 4 to 6 feet. The exposed side areas 20A, 20B may each have a width WP of, for example, from about 1 to 2 feet.

The box is designed so that all of its contents can be accessed from outside, without the need to walk into the trailer. Accordingly, the box does not need to be as high as the typical body of a work trailer, which is generally designed so that a user can walk inside to remove the contents. Thus, the height of trailer 10 measured from the ground to the highest point on the exterior of the box is typically less than 8 feet and can be as low as 6 feet or less. This is achieved by having the box 12 have a relatively low height H (FIG. 1), for example less than 5 feet. In some implementations, the height H is from about 4 to 5 feet. The height of the box is selected to be sufficient to accommodate the equipment that will be stored in the trailer, while being low enough to provide good handling while pulling the trailer.

Because the height of the trailer is relatively low (compared to conventional construction trailers, which are often 10 feet or more from ground to highest point) the center of gravity of the trailer is also low. This low center of gravity makes the trailer less likely to tip over, enhancing user safety, and easier to tow on challenging terrain. The weight distribution of the trailer, which is predominantly over or close to the longitudinal axis if the trailer (due to the box being narrower than the platform) also contributes to ease of handling when towing.

Referring to FIGS. 1-1B, on a first side of the trailer 10 the box 12 includes three medium sized side bays 22, 24 and 26 and a front bay that is accessed through a front bay door 28. Each of these bays has a sliding door that rolls upward into the bay. As noted in the Other Embodiments section below other types of doors may be used instead of sliding doors. The depth of bays 22 and 24 may be, for example, about half the width of the box 12, e.g., about 3 to 5 feet in some implementations. The sliding doors are trimmed with drip edge 25 to prevent rainwater from entering the bays. The drip edge may also be trimmed with LED strip lighting. The platform 14 includes compartments 30, 32 and 34 having top-opening doors. The compartments may be, for example, about 10 to 16 inches high. All of the bays and compartments are accessed by the user from the outside of the trailer. The top surfaces of the compartments 30, 32 and 34 can be used as a bench to work on, a stand, and a place to step up on and strap to. The platform includes running boards 36 that can be used to step up onto the top of the compartments to reach the roof of the trailer, e.g., to access a lumber rack or other roof rack (not shown).

Referring to FIG. 1A, depending on the customization of the trailer, bay's 22 and 24 may include pull-out tables 38, 40, as shown. These tables may be used, for example, to support a saw (table 38), anvil (table 40), or any other desired equipment or tools. Table 38 slides out on a pair of guide rails 42 (only one of which is visible in FIG. 1A), while table 40 is supported by a rod 44 that slides into and out of a housing 46. Table 40, and lower portion 38A of table 38, are supported by folding legs 39 that are dimensioned to contact the ground. If desired, the tools that are to be used on the tables can be stored on the tables and (for power tools) plugged into outlets (not shown) in the back walls of the bays. This saves wear and tear on the user by minimizing lifting and carrying of heavy tools, potentially reducing the incidence of back injuries and other safety issues at the jobsite. Moreover, the slide out features and platform workspaces make it very quick and easy to deploy, use and re-store the tools. This can be particularly helpful at a job site that lacks a good place to set up a workspace, and/or where tools must be secured from theft at all times.

Referring now to FIG. 1B, to provide shelter for a user working at the tables, a tent 50 can be deployed from a compartment 48 (FIG. 1A). Tent 50 can have any desired configuration that can be stored within the upper area of the box 12, for example in FIG. 1B tent 50 consists of a pair of folding panels 52A, 52B and legs 54A, 54B. Alternatively, the tent can be a fabric awning with poles, similar to a conventional pop-up tent but with two sides supported by the box.

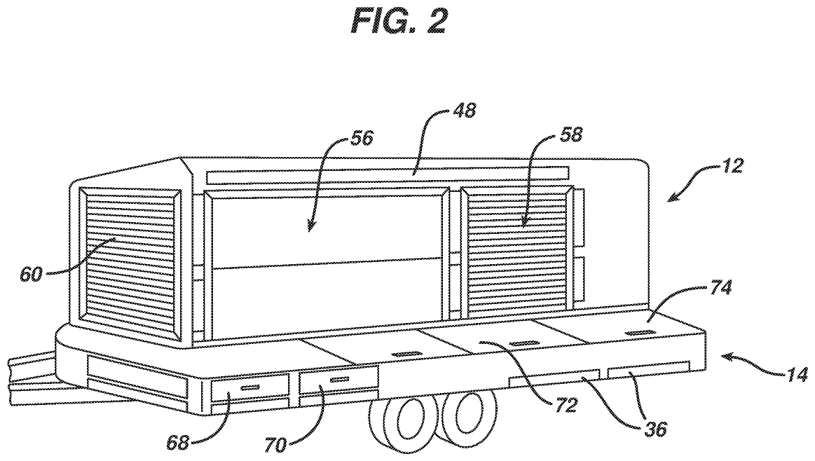

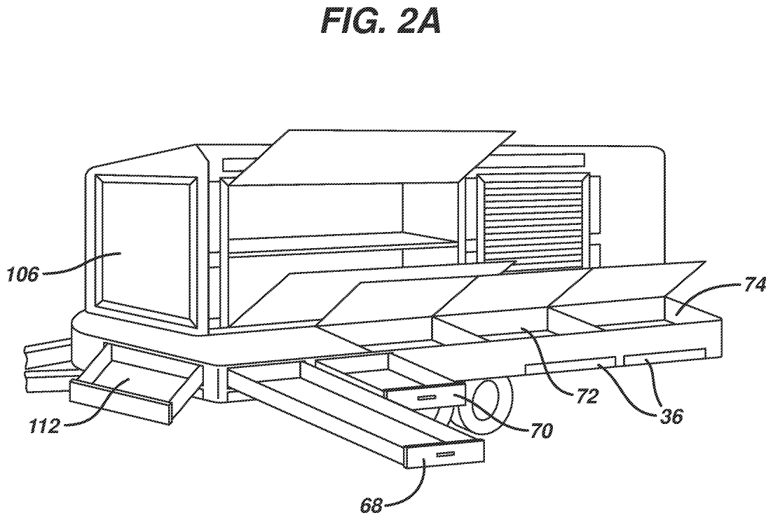

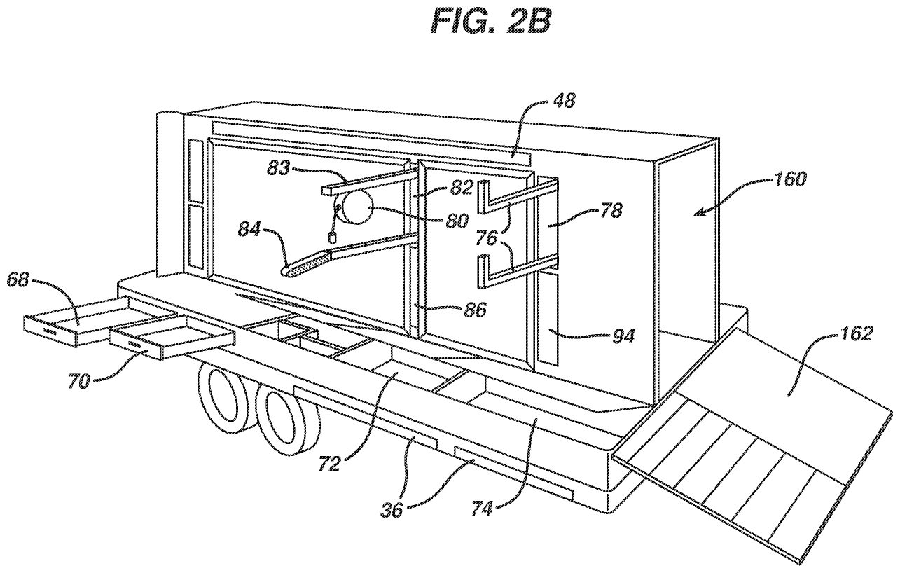

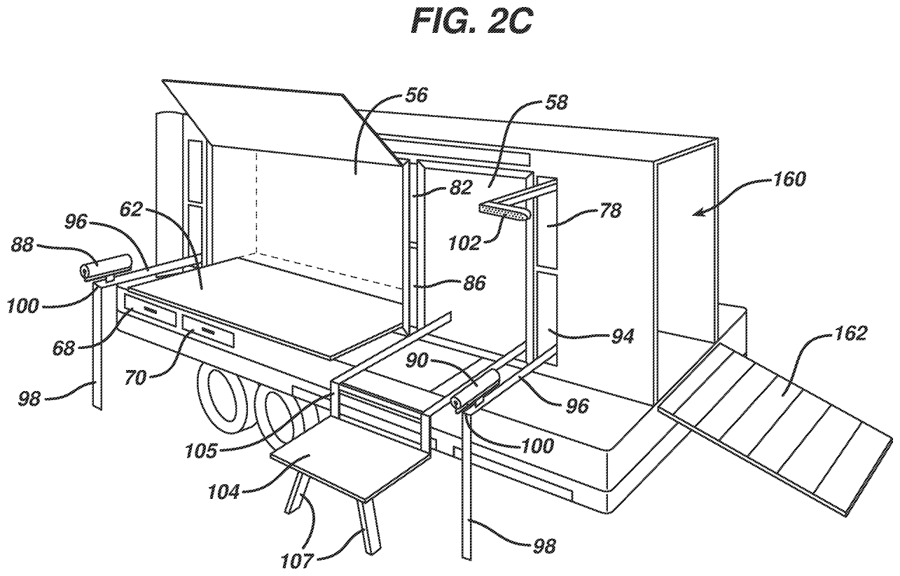

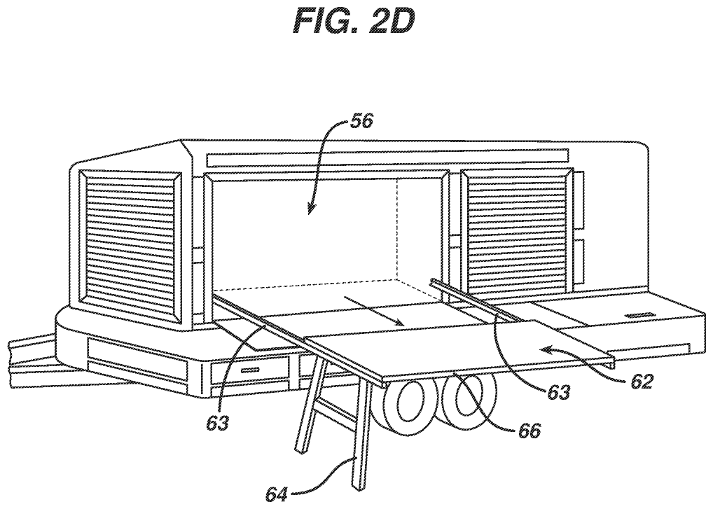

Turning now to FIGS. 2-2D, on the opposite side of the trailer 10 the box 12 includes a large bay 56 with top and bottom opening doors (shown in an open position in FIGS. 2A and 2C), a smaller bay 58 with a sliding roll up door, and a front bay that is accessed by a front bay door 60. As will be discussed below; front bay door 28 on the opposite side and front bay door 60 on this side may access two separate front bays, or the two front bay doors can be used to access a single large front bay from opposite sides. Compartment 48 houses a second tent, which may be of the same or different construction as tent 50 discussed above.

Large bay 56 can be used, for example, for large and/or frequently used equipment. As shown in FIGS. 2C and 2D, when the doors of bay 56 are opened a table 62 can slide forward on rails 63 and be deployed (FIG. 2D). Legs 64 (of which only the left-hand set is shown deployed in FIG. 2D) fold out from under the table panel 66. If desired the legs can be telescoping, for example with their lengths being adjustable using ball spring bearings or the like.

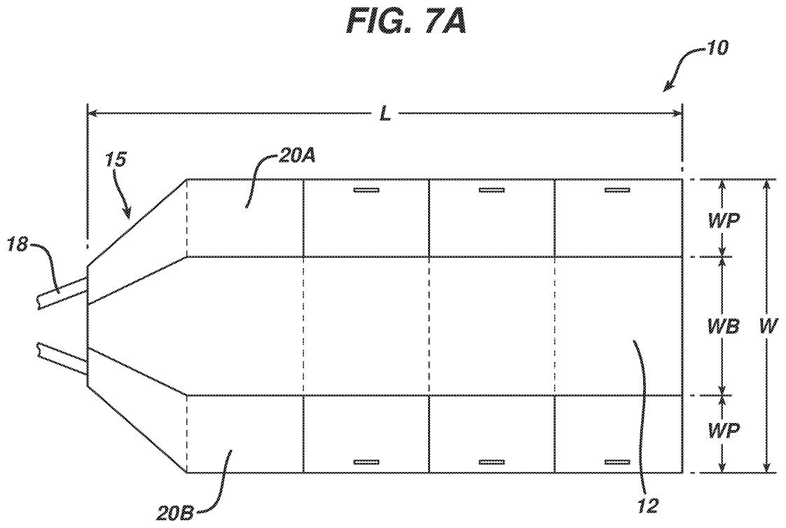

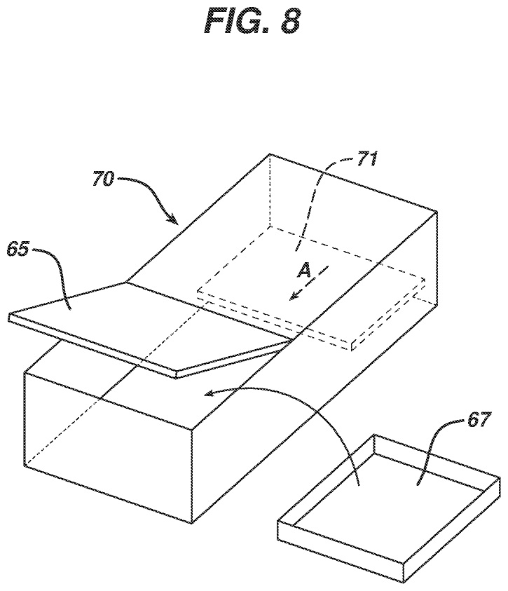

Referring again to FIGS. 2 and 2A, the platform on this side of the trailer includes a long drawer 68 which runs the entire width of the platform, and thus can be used for long items such as levels, laser sticks and house wrap. In some implementations this drawer can be fitted with foam or other padding to protect delicate items such as levels. The frame supporting the long drawer may be reinforced to withstand the lever arm exerted by the long drawer and its contents when the drawer is pulled out. Next to the long drawer 68 is a shorter drawer 70 (shorter because of the compartment provided on the opposite side of the platform.) As shown in FIG. 8, either or both of these drawers can include a hinged lid 65, and an inner box 67 that can be removed to allow a sliding shelf 71 to be pulled forward (arrow A) to provide access to stored items in the back of the drawer.

From the wheels back there are three storage areas with top-opening doors. The area over the wheels will be discussed further below with reference to FIG. 7. The other two compartments 72, 74 are similar to the compartments 30, 32 and 34 on the other side of the platform.

FIG. 2B shows various pieces of pull-out equipment deployed. A ladder rack 76 has been pulled out of a compartment 78, an extension cord reel 80 (supported from above by a rod 83) has been pulled out of a compartment 82, and an LED light array 84 has been pulled out of a compartment 86. The LED light array and extension cord are powered by the electrical system of the trailer, as will be discussed in further detail below.

Other pull-out features are shown in FIG. 2C. A pair of roller racks 88, 90 pull out of corresponding compartments 92, 94, and can be used to support lengths of lumber that are being cut on the table 62. Each of the roller racks includes a horizontal support 96 and a vertical support 98, which are deployed and folded up via a hinge 100. In FIG. 2C, instead of the ladder rack 76, compartment 78 houses an LED light array 102 (FIG. 2C shows an alternate customization in this regard.) FIG. 2C also shows the deployment of a second, smaller table 104 from bay 58. The height of table 104 can be adjusted by sliding it up and down on vertical rails 105 and adjusting the length of telescoping legs 107. In some implementations table 104 is rated for heavy loads and includes an assist for deploying and retracting it with a heavy load in place on the table surface. This can also be the case with table 62, discuss above.

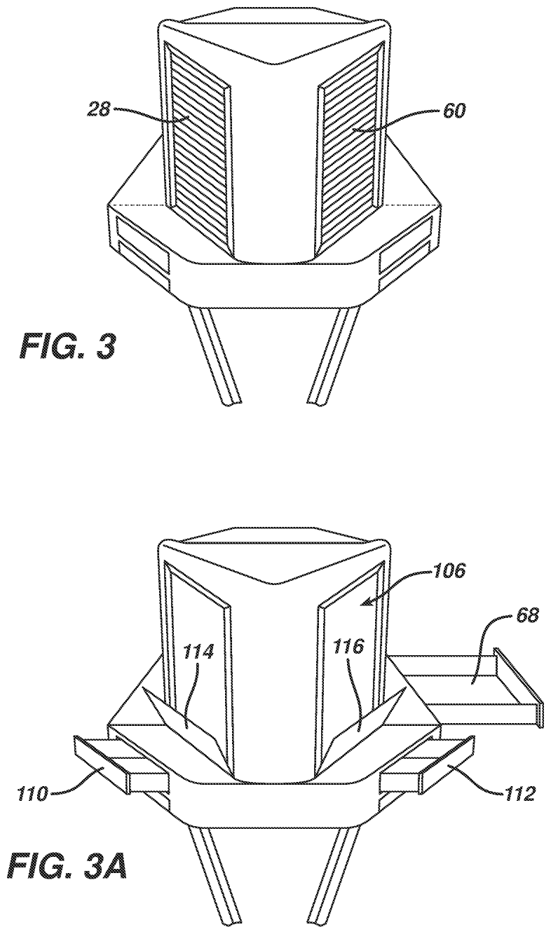

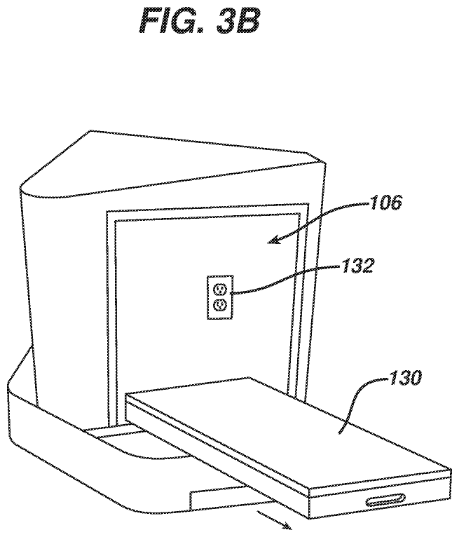

The electrical and power features of the trailer originate at the front end, shown in detail in FIGS. 3-3B. The primary goals of the electrical system are to provide maximum functionality to all areas of the trailer and allow the user to work self-sufficiently at the jobsite. As discussed above, the front bay doors 28 and 60 may access two separate front bays or a single large front bay. In either case, the front bay area 106 is intended for storage of a generator and compressor. For safety and noise suppression the front bay area is generally lined with a fire resistant and sound suppressing material. Keeping the generator and compressor in the front bay area keeps the equipment safe from damage or theft and out of the weather, and also helps to minimize distracting levels of noise.

Referring to FIG. 3A, the front end also includes drawers 110 and 112, the contents of which can be accessed either by pulling the drawers our or (which may be more convenient for accessing wired-in contents) flipping up lids 114, 116. Lids 114, 116 also facilitate reaching wiring at the back of or behind the drawers. Drawers 110 and 112 may contain, for example, a breaker panel/fuse box and a power bank (not shown). The power bank can be used to run power tools without the need to run the generator continuously, providing a quieter workplace. The power bank can be wired to be charged by the truck and/or by one or more portable solar panels. In some cases, the entire electrical system can be charged by the truck engine. By positioning the power bank and breaker/fuse box in the front-end drawers they can be easily wired to the generator.

Referring to FIG. 3B, a slide out shelf 130 is provided to allow the generator to be easily accessed for refueling and maintenance. An outlet 132 is provided in the front bay area 106, for example for plugging in a compressor.

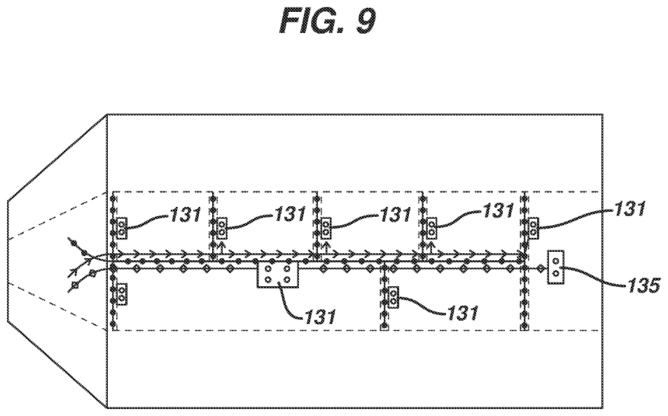

Referring to FIG. 9, wiring extends through the length of the trailer, providing power to all bays. The wiring can be routed through the box frame 230 (FIGS. 10 and 11), which may be formed of tubular members (e.g., 1 in. square cross-section tubing), such that power is supplied to some or all of the bays. As shown in FIG. 9, the wiring can include 110V wiring (indicated with arrows) for the bay 110V outlets 131, 220V wiring (indicated with diamonds) for a 220V outlet for large equipment in the rear bay, and 12V wiring (indicated with circles) for the LED lighting.

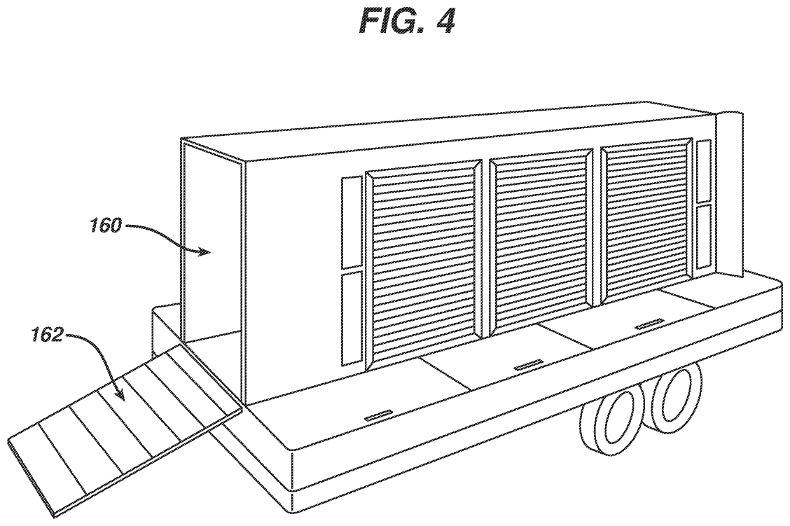

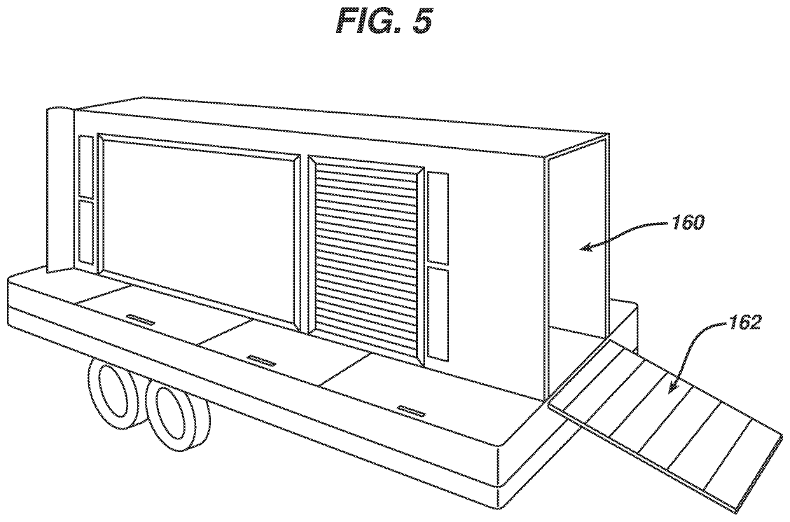

Referring now to FIGS. 4-6A, the trailer includes a rear bay 160 that has a ramp 162 to allow easy access to large, heaving rolling equipment (e.g., large tool chests, flooring equipment, welders, fusers, sanders, etc.). The rear compartment can have a depth of, for example, from about 2 feet to 6 feet, and generally runs the entire width of the box 12. The rear bay 160 may have a door that drops down to provide the ramp 162, as shown in the figures. If desired an assist (not shown) can be provided for lifting the door.

The floor of the rear compartment can either be level with the upper surfaces of the platform compartments, as shown in FIGS. 1A, 2B and 4-6. Alternatively, the floor of the rear compartment can be level with the upper surface of the platform frame, as shown in FIG. 2C.

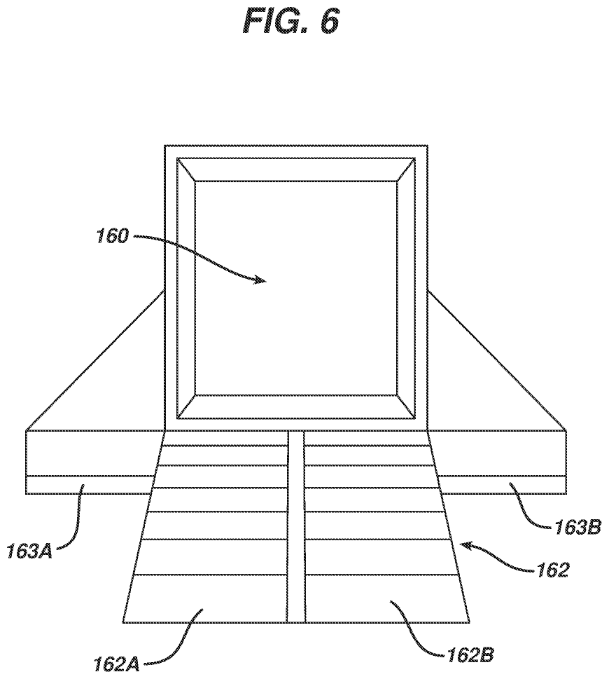

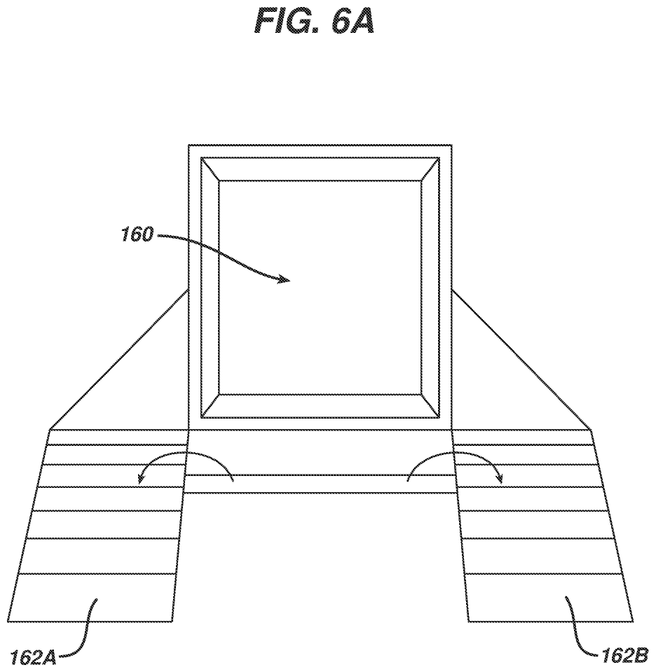

The first alternative has the advantage that the ramp can be configured to also be used as smaller ramps for the upper surfaces of the platform compartments. For example, as shown in FIGS. 6 and 6A the ramp can include two separable portions 162A, 162B. Portions 162A/B can be locked together to provide a ramp for bay 160 (FIG. 6) and separated and positioned below the platform compartments (FIG. 6A), e.g., flipped over as indicated by the arrows, to provide a ramp for each platform compartment surface. Locking of the two portions can be accomplished as is well known in the bifold ramp art. Having this multi-use ramp configuration allows the elongated open spaces 163A, 163B below the platform compartments to be used for storage, for example sliding storage for long items such as ladders.

The alternative shown in FIG. 2C has the advantage that the rear bay has an additional foot of height, without increasing the ground-to-highest point height of the trailer. This allows tall equipment to be stored in the rear bay, and in some implementations allows the rear bay to be used as a small walk-in bay. In this embodiment it is generally necessary to utilize pull-out ramps (e.g., of the type often used in moving vans) in the spaces 163A, 163B, that otherwise could be used for ladder storage, if ramps are desired for the platform compartments. In some applications it is advantageous to have the surfaces of the platform compartments accessible by ramps, for example to easily remove and replace heavy tools that need to be used away from the trailer, while in other applications this may not be necessary.

Referring now to FIG. 7, platform 14 is built up from a base frame 190 that includes an outer rectangular frame 200, a front extension 202 in the form of a truncated triangle and having a dividing member 204, and a plurality of reinforcing members 206 that extend crosswise within the frame 200. Reinforcing members 206 impart strength to frame 200 and support the weight of the bay's that together with the box frame 230 form the box 12.

A three-dimensional platform frame 240 is welded to the base frame, as shown in FIGS. 10 and 11, and the box frame 230 is generally bolted to the platform frame to allow for customization of the platform/box combination by the manufacturer. Base frame 190 includes one or more axles and a trailer hitch (not shown in FIG. 7), and can be configured, for example, as a 16 ft. double-axle trailer base rated for 14000 lbs., or an 8 ft. single-axle trailer base rated for 7000 lbs. The larger size base frame would provide a trailer 10 having sufficient room to outfit an entire work crew, while the smaller size would be intended for one or two users and could in some cases be towed by a passenger car. The ground clearance for the base frame, with axles and wheels mounted, would be the same as for a standard single or double axle trailer.

As shown diagrammatically in FIG. 7, the central area of the platform frame, between tires 210, can be used to store one or more liquid tanks 212, a pump 214, and other components of a liquid delivery system. The liquid delivery system can be used to store and deliver water, gasoline, kerosine, or other fluids as desired. If combustible/flammable liquids are to be stored proper safety measures are taken such as providing suitable tanks for such materials. If water is stored it can be used, for example, to supply a pressure washer or handwashing station.

Referring to FIGS. 10 and 11, the platform frame 240 is constructed to receive the drawers and other platform storage compartments discussed above, with the assembled platform frame and compartments forming the finished platform 14. The box frame 230 is constructed to receive the various bays discussed above (or a different configuration of bays), with the bays and box frame forming the finished box 12. The platform frame and box frame provide a strong, rigid structure for the compartments and bays, and a very strong and robust overall trailer construction. Moreover, the tubular steel construction allows wiring and other tubing to be routed through the frame, as discussed above. The scaffold provided by each frame allows customization of the platform by removing and replacing compartments and bays, which may in some cases be removably bolted into the frames.

The trailer may include a wide variety of optional features to customize the trailer for use in various applications and work settings. For example, the box may include one or more lumber racks or other roof racks designed for particular applications (e.g., for pipes for use in plumbing, for bicycles or watercraft, etc.).

A Bluetooth® wireless system may be included to control a lock system and/or to turn the power system off and on, or selectively turn the generator and lights off and on. A fob may be used to control the wireless system, and/or the system may be controlled by a mobile phone app. Other security features may be included such as motion-activated floodlights and/or alarms to deter would-be thieves. One or more of the bay doors may be configured to automatically open in response to remote activation.

Other optional features include devices that can assist with providing a self-contained workspace such as a pull-out hand washing station, a sink, or a microwave.

### Other Embodiments

A number of embodiments have been described. Nevertheless, it will be understood that various modifications may be made without departing from the spirit and scope of the disclosure.

For example, while the use of the work trailers in construction has been discussed above, the trailers can be customized for use in a wide variety of other applications. For example, the trailers can be used in mining, painting, electrical work, plumbing, landscaping, horseshoeing, welding, mobile veterinary services, auto detailing, and many more. The trailers may include specific options tailored to various applications, e.g., refrigeration, protection or shielding for special equipment, pressure washing equipment, high temperature heating equipment, welding equipment, etc.

Moreover, while certain configurations of bays and compartments have been shown in the drawings and described above the bays and compartments can be configured in any desired manner. For example, any of the bays can have any desired type of door, including but not limited to roll-up doors, louvered doors, sliding doors, and horizontal or vertical hinged doors with strap hinges or other types of hinges. Any desired type of handles, latches, etc. may be used.

Additionally, while tubular steel has been discussed above as a material for the frame, many different materials may be used in the construction of the trailer, as will be apparent to those of skill in the art. For example, the trailer may include any one or more of aluminum, steel, plastic, composites, wood, and fiberglass.

Accordingly, other embodiments are within the scope of the following claims.

What is claimed is:

1. A work trailer comprising:
a trailer platform having a length and width, and
a box fixedly mounted on the platform, the box extending substantially the entire length of the platform but covering only a portion of the width of the platform, leaving an exposed strip of platform running the length of the platform on either side of the box.

2. The trailer of claim 1 wherein the height of the trailer from the ground to a highest point is less than 8 feet.

3. The trailer of claim 1 wherein the width of the box is from about 3 to 6 feet.

4. The trailer of claim 3 wherein the platform is from about 4 to 9 feet wide.

5. The trailer of claim 1 wherein the box includes a plurality of box storage areas accessible from outside the trailer.

6. The trailer of claim 5 wherein the box comprises a rigid box frame and the box storage areas comprise modular bays that are reconfigurably mounted on the rigid frame.

7. The trailer of claim 6 wherein the platform comprises a rigid platform frame providing a three-dimensional scaffold.

8. The trailer of claim 7 further comprising platform storage compartments that are disposed within the scaffold provided by the platform frame.

9. The trailer of claim 1 further comprising an electrical system including a power bank and wiring providing electrical communication between the power bank, a power source, and power outlets in the box.

10. The trailer of claim 9 wherein the electrical system further comprises a breaker panel.

11. The trailer of claim 9 wherein the wiring is routed through a frame of the box.

12. A work trailer comprising:
a platform having an upper surface, the platform comprising
a trailer hitch,
a platform frame mounted on one or more wheeled axles, the platform frame providing a three-dimensional scaffold, and
a plurality of storage compartments within the scaffold, and mounted on the platform frame, a box comprising
a box frame mounted on the upper surface of the platform, and
a plurality of bays secured within the box frame.

13. The trailer of claim 12 wherein the box-shaped frame covers only a portion of the upper surface of the platform.

14. The trailer of claim 12 wherein all of the compartments and bays are accessible from outside of the work trailer.

15. The trailer of claim 12 wherein the box-shaped frame is constructed of tubular members and the trailer further comprises wiring extending through the tubular members from a power supply to outlets in the bays.

16. The trailer of claim 12 further comprising one or more tanks for liquid storage disposed within the platform frame.

17. The trailer of claim 12 wherein the box frame is bolted to the platform frame to allow removal and replacement of the box.

18. The trailer of claim 12 wherein the height of the trailer from the ground to a highest point is less than 8 feet.

19. The trailer of claim 12 further comprising an electrical system including a power bank and wiring providing electrical communication between the power bank, a power source. and power outlets in the box.

20. The trailer of claim 19 wherein the electrical system further includes a 12V lighting system.
